(19) United States
(12) Patent Application Publication
(10) Pub. No.: US 2021/0164791 A1
(43) Pub. Date: Jun. 3, 2021

(54) DEVICE, SYSTEM AND METHOD FOR TRANSPORTING OCCUPANTS OF VEHICLES TO A LOCATION FOR ASSISTANCE

(71) Applicant: MOTOROLA SOLUTIONS, INC., Chicago, IL (US)

(72) Inventors: Jakub HALUN, Krakow (PL); Michal JANDA, Krakow (PL)

(21) Appl. No.: 15/734,371

(22) PCT Filed: Jul. 5, 2018
(86) PCT No.: PCT/PL2018/050032

§ 371 Date: Dec. 2, 2020

(51) Int. Cl. G01C 21/34; G08G 1/00; G08G 1/09; G01C 21/36; G06Q 50/26; G06Q 10/04

(52) U.S. Cl. CPC G01C 21/3438; G08G 1/202; G06Q 10/047; G01C 21/3691; G06Q 50/265; G08G 1/09

(57) ABSTRACT

A device, system and method for transporting occupants of vehicles to a location for assistance is provided. A controller receives, via a communications unit, from a vehicle, a request to assist at least one occupant of the vehicle. The controller determines, from map data accessible by the controller, a combination of a meeting place and a corresponding rescue vehicle, selected from a plurality of rescue vehicles, which minimizes a total travel time of the vehicle from a current location to the meeting place, and the corresponding rescue vehicle from the meeting place to a location for assisting the at least one occupant. The controller transmits, using the communications unit, to each of the vehicle and the corresponding rescue vehicle, respective navigation instructions to the meeting place.

### BACKGROUND OF THE INVENTION

In emergency situations, when human life is at risk, every second counts. When an occupant of a vehicle and/or an autonomous vehicle requires assistance, such as medical assistance, quickly transporting to a location for assistance can be important in ensuring that the occupant receives timely attention and/or treatment.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a system for transporting occupants of vehicles to a location for assistance in accordance with some embodiments.

FIG. 2 depicts an example computing device in according with some embodiments.

FIG. 3 depicts a flowchart of a method for transporting occupants of vehicles to a location for assistance in accordance with some embodiments.

FIG. 4 depicts a device determining meeting places that a vehicle may meet different rescue vehicles to transport to a location for assistance in accordance with some embodiments.

FIG. 5 depicts the device selecting one of meeting places and a corresponding rescue vehicle and transmitting navigation instructions to the meeting place in accordance with some embodiments.

FIG. 6 depicts the device dynamically updating the meeting place and transmitting navigation instructions to the updated meeting place in accordance with some embodiments.

FIG. 7 depicts a scenario where a selected meeting place is in a direction opposite a direction to location for assistance in accordance with some embodiments.

FIG. 8 depicts a scenario where a selected meeting place is in a direction opposite a direction of travel of a vehicle in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

An aspect of the specification provides a device comprising: a communications unit configured to communicate with a vehicle and a plurality of rescue vehicles; and a controller communicatively coupled to the communications unit, the controller having access to map data, the controller configured to: receive, from the vehicle, via the communications unit, a request to assist at least one occupant of the vehicle; determine, from the map data, a combination of a meeting place and a corresponding rescue vehicle, selected from the plurality of rescue vehicles, which minimizes a total travel time of the vehicle from a current location to the meeting place, and the corresponding rescue vehicle from the meeting place to a location for assisting the at least one occupant; and transmit, using the communications unit, to each of the vehicle and the corresponding rescue vehicle, respective navigation instructions to the meeting place.

Another aspect of the specification provides a method comprising: receiving, at a controller, via a communications unit, from a vehicle, a request to assist at least one occupant of the vehicle; determining, at the controller, from map data accessible by the controller, a combination of a meeting place and a corresponding rescue vehicle, selected from a plurality of rescue vehicles, which minimizes a total travel time of the vehicle from a current location to the meeting place, and the corresponding rescue vehicle from the meeting place to a location for assisting the at least one occupant; and transmit, from the controller, using the communications unit, to each of the vehicle and the corresponding rescue vehicle, respective navigation instructions to the meeting place.

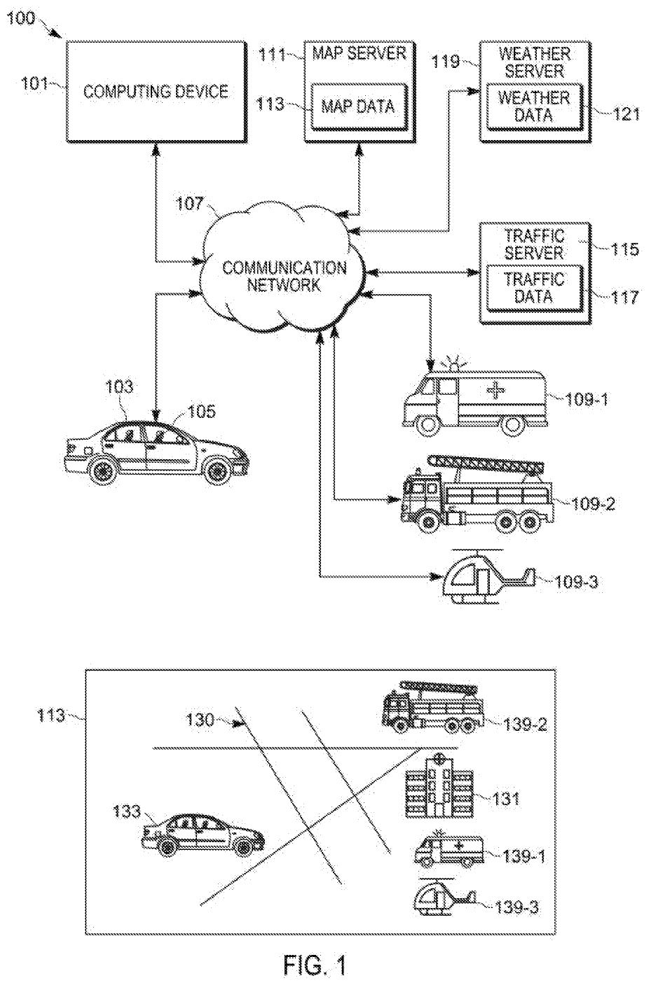

Attention is directed to FIG. 1, which depicts a system 100 for transporting occupants of vehicles to a location for assistance. The system 100 comprises a computing device 101, at least one vehicle 103, that includes at least one occupant 105, a communication network 107, and a plurality of rescue vehicles 109-1, 109-2, 109-3 each of which may include an emergency services vehicle and/or public safety vehicle and the like, such as an ambulance, a fire truck a helicopter and the like, though any type of vehicle that may be used as a rescue vehicle and/or an emergency service vehicle is within the scope of the present specification. As described below, in some examples the computing device 101 may comprise a cloud-based device, while in other examples the computing device 101 may be a component of the at least one vehicle 103. In yet further examples, functionality of the computing device 101 may be distributed between components of the system 100 including, but not limited to, a cloud-based device and the at least one vehicle 103.

The system 100 optionally comprises a map server 111, and the like, storing map data 113; alternatively, the map data 113 may be stored at a memory of the computing device 101. Regardless, the computing device 101 has access to the map data 113. As depicted, the system 100 optionally comprises a traffic server 115, and the like, storing and/or maintaining traffic data 117; and/or the system 100 optionally comprises a weather server 119, and the like, storing and/or maintaining weather data 121. Alternatively, one or more of the traffic data 117 and the weather data 121 when present, may be stored and/or maintained at a memory of the computing device 101.

The computing device 101 is interchangeably referred to hereafter as the device 101, the at least one occupant 105 is interchangeably referred to hereafter as the occupant 105, the communication network 107 is interchangeably referred to hereafter as the network 107, and the plurality of rescue vehicles 109-1, 109-2, 109-3 are interchangeably referred to hereafter, collectively, as the rescue vehicles 109 and, generically, as a rescue vehicle 109.

The device 101 is generally configured to communicate with each of the vehicle 103, the rescue vehicles 109 and, when present, the map server 111 and/or the traffic server 115 and/or the weather server 119, via the network 107 using respective wired and/or wireless communication links depicted in system 100 as arrows between the components of the system 100 and the network 107.

The device 101 may comprise one or more cloud computing devices and/or servers, and may be operated by a public service and/or emergency service entity, such as a police service entity, a fire service entity, an emergency medical service entity, and the like. However, the device 101 may be operated by another type of entity including, but not limited to, a commercial and/or business entity. Indeed, the device 101 may generally provide a service for automatically deploying a rescue vehicle 109 to a meeting place to meet the vehicle 103 in order to transfer the occupant 105 requiring assistance to the rescue vehicle 109, for transport to a location for assisting the occupant 105. For example, the occupant 105 of the vehicle 103 may sign up and/or register for such a service, for example using a communication device and the like, and provide permission to the device 101 to access a current location of the vehicle 103. Alternatively, such a service may be offered to employees of an emergency service (e.g. the vehicle 103 may comprise an emergency service vehicle such as a police car and the like). Alternatively, such a service may be offered to customers and/or employees of a commercial and/or business entity.

Furthermore, each of the vehicle 103 and the rescue vehicles 109 are configured to communicate with the device 101, and further configured to provide and/or implement navigation instructions to navigate to a location, such as a meeting place, as described in more detail below. Furthermore, the device 101 is generally configured to determine a current location of the vehicle 103 and each of the rescue vehicles 109; for example, the vehicle 103 and each of the rescue vehicles 109 may periodically report their current location to the device 101 and/or the device 101 may communicate with network infrastructure to determine the current location of the vehicle 103 and each of the rescue vehicles 109 (for example using triangulation techniques, street-deployed cameras, and/or other types of network infrastructure, and the like).

The vehicle 103 may comprise any vehicle configured to transport the occupant 105 and navigate to a location based on navigation instructions. While not depicted, the vehicle 103 may generally comprise a computing and/or communication device, for example for implementing processes of the vehicle 103 and communicating with the device 101 as described hereafter. In general, the vehicle 103 is further configured to determine when the occupant 105 may require assistance, such as medical assistance. In some examples the sensors of the vehicle may detect specific conditions and/or medical conditions of the occupant 105, such as when the occupant 105 one or more of: is injured; is unconscious and/or has fainted; is having a heart attack; not breathing; is experiencing an abnormal heart rate; is hemorrhaging; is experiencing an abnormal temperature; has a head trauma; and the like. Indeed, the vehicle 103 may be configured to automatically transmit, to the device 101, a request to assist the at least one occupant 105 of the vehicle 103 when the sensors detect a given condition and/or medical condition of the occupant 105.

In yet further examples, the vehicle 103 may comprise a user interface, such as a physical button and/or a virtual button provided at a graphic user interface of a display screen of the vehicle 103, which, when actuated, causes the vehicle 103 to transmit, to the device 101, a request to assist the at least one occupant 105 of the vehicle 103. Alternatively, a command to initiate a request to assist the at least one occupant 105 of the vehicle 103 may be received at a microphone of the vehicle 103 which, when received, causes the vehicle 103 to transmit, to the device 101, a request to assist the at least one occupant 105 of the vehicle 103.

In yet further examples, the sensors of the vehicle 103 may be configured to determine one or more of a state of the vehicle 103, a condition of the at least one occupant 105 (as described above), and a number of occupants 105 needing assistance, and include such information in the request for assistance. A state of the vehicle 103 may include one or more: a current direction of travel of the vehicle 103; a current maximum available speed of the vehicle 103 (e.g. which may be based on damage to the vehicle 103 and/or battery and/or fuels levels); whether or not the vehicle 103 is operational, and/or damaged and/or able to drive and/or able to drive safely; battery and/or fuel levels; tire pressure; and the like. The state of the vehicle 103 may further indicate whether the vehicle 103 was in an accident and hence may further indicate whether an injury and/or condition of the occupant 105 is due to an accident.

In some examples, the vehicle 103 comprises an autonomous vehicle configured to automatically navigate to a location, including, but not limited to, a meeting place with a rescue vehicle 109, based on navigation instructions received, for example from the device 101 in response to transmitting the request for assistance. Hence, for example, when the occupant 105 is a sole occupant of the vehicle 103 and is rendered unconscious and/or has fainted, and the like, for example due to a medical condition, while the vehicle 103 is in motion (e.g. driving), the vehicle 103 may automatically detect that the occupant 105 requires assistance and transmit a request for assistance to the device 101. In response, as described below, the vehicle 103 may receive navigation instructions to a meeting place for meeting a rescue vehicle 109 for transport to a location for assisting the occupant 105, such as a hospital, a clinic, a police station, a fire station, and an emergency medical services station, and the like. However, any suitable location for assisting the occupant 105 is within the scope of the present specification including, but not limited, to commercially operated locations and/or locations associated with a business entity, and the like.

However, in other examples, such as when the vehicle 103 comprises a user interface which, when actuated, transmits the request for assistance, the vehicle 103 may not be an autonomous vehicle and the received navigation instructions (e.g. to a meeting place with a rescue vehicle 109) are provided at an output device of the vehicle 103, such as a display screen and/or a speaker. In such examples, a person of skill in the art understands that an occupant 105 of the vehicle 103 may manually drive the vehicle to the meeting place based on the provided navigation instructions.

While only one vehicle 103 is depicted in FIG. 1, the system 100 may comprise a plurality of vehicles carrying one or more respective occupants, and the device 101 may determine navigation instructions to a respective meeting place for any of the plurality of vehicles that requests assistance for a respective occupant.

Furthermore, while the vehicle 103 is depicted as a land-based vehicle, such as a car, a truck, a van, and the like, the vehicle 103 may, in some examples, comprise a water-based vehicle, such as a boat, and the like, and/or, in other examples, comprise an air-based vehicle such as a plane, a helicopter, and the like.

Each of the rescue vehicles 109 comprises a respective vehicle configured to navigate to a meeting place to meet with the vehicle 103, and transport the occupant 105 needing assistance to a location for assisting the occupant 105. While not depicted, each of the rescue vehicles 109 may generally comprise a computing and/or communication device, for example for implementing processes and communicating with the device 101 as described hereafter. While three rescue vehicles 109 are depicted, the system 100 may comprise as few as two rescue vehicles 109 and more than three rescue vehicles 109. Furthermore, as depicted, the rescue vehicles 109 include an ambulance (rescue vehicle 109-1), a fire truck (rescue vehicle 109-2) and a helicopter (rescue vehicle 109-3), however other types of rescue vehicles are within the scope of the present specification, including, but not limited to, a police vehicle, and the like. Furthermore, while the rescue vehicles 109 include two land-based rescue vehicles (e.g. the ambulance and the fire truck), and an air-based rescue vehicle (e.g. the helicopter), the rescue vehicles 109 may include one or more water-based rescue vehicles, such as a boat, and the like. Indeed, the rescue vehicles 109 may include any suitable combination of two or more rescue vehicles. Furthermore, one or more of the rescue vehicles may include autonomous rescue vehicles, however in examples where an autonomous rescue vehicle is unmanned, the unmanned autonomous rescue vehicle may be adapted to transfer the occupant 105 to the autonomous rescue vehicle at the meeting place for transport to a location for assisting the occupant 105; however, in examples where there are two occupants 105 of the vehicle 103, and only one occupant 105 requires assistance, the other occupant 105 may transfer the occupant 105 requiring assistance to the unmanned autonomous rescue vehicle. Indeed, any suitable rescue vehicle is within the scope of the present specification.

Also depicted in FIG. 1 is an example of the map data 113 which includes features 130 such as roads and the like, as well as a location 131 for assisting the occupant 105, as depicted, a hospital. However, the location 131 may alternatively include a clinic, a police station, a fire station, and an emergency medical services station, and the like. For clarity, the map data 113 also includes a current location 133 of the vehicle 103, as well as current respective locations 139-1, 139-2, 139-3 of each of the rescue vehicles 109-1, 109-2, 109-3. Hence, the depiction of the map data 113 in FIG. 1 may represent the map data 113 after the device 101 has located the vehicle 103 and the rescue vehicles 109 at the map data 113. The locations 139-1, 139-2, 139-3 are interchangeably referred to hereafter, collectively, as the locations 139 and, generically, as a location 139. Furthermore, one or more of the locations 139 may be different from the other locations and/or the one or more of the locations 139 may be the same.

The map data 113 may further include, but is not limited to: landform/terrain information (e.g. whether a road is bumpy or not): information about open spaces without overhead power lines and/or overhead obstructions (e.g. trees), available for landings (e.g. for air-based vehicles and/or rescue vehicles); information regarding landing spots (e.g. for air-based vehicles and/or rescue vehicles) which may be in close proximity to a road and/or connected to a road by a footpath and/or with an open space between a road and the landing spot and/or where there are no barriers (such as fences and the like) between a road and the landing spot; and the like. Indeed, the map data 113 may include any data for determining a meeting place to which the vehicle 103 and a rescue vehicle 109 may each navigate to transfer the occupant 105 requiring assistance from the vehicle 103 to the rescue vehicle 109.

Furthermore, the map data 113 and/or the traffic data 117 and/or the weather data 121 may include, but is not limited to: speed limits of roads; current and/or historical information about roads; passability of roads (including whether blocked by snow, mud, and the like); whether the roads are open, closed and/or blocked due to traffic; current and/or historic and/or predicted traffic conditions of the roads due to business, schools and the like (e.g. when shifts end in a factory and/or when school starts or ends); current weather information which may include weather conditions such as strong wind, snow, rain and the like (e.g. which may prevent the landing of an air-based vehicle); forecast of weather changes and/or traffic changes within a given time period; and the like. Indeed, the traffic data 117 and/or the weather data 121 may enable the device 101 to predict traffic conditions and/or weather conditions to better determine a meeting place for the vehicle 103 and a rescue vehicle 109.

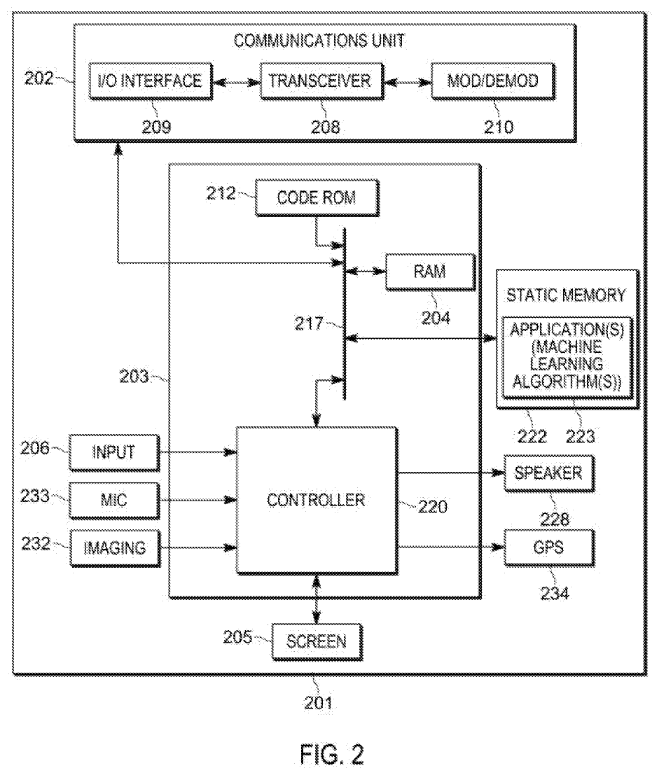

Attention is next directed to FIG. 2 which sets forth a schematic diagram that illustrates an example of a computing device 201, interchangeably referred to hereafter as the device 201 and/or the example device 201. The device 101 may have a configuration similar to the example device 201. Furthermore, computing devices at one or more of the vehicle 103 and the rescue vehicles 109 may have a configuration similar to the example device 201. However, the configuration of the example device 201 may be adapted for a particular respective configuration of the device 101 and/or the vehicle 103 and/or the rescue vehicles 109. For example, the device 101 may not include input devices and/or output devices (such as a display screen, speakers, microphones, keyboards and the like), and vehicle 103 and/or the rescue vehicles 109 may include components for navigating and/or autonomous vehicle navigation system and the like; furthermore, the vehicle 103 may include sensors for determining a condition of the occupant 105 and/or whether the occupant 105 is in need of assistance and/or sensors for determining a state of the vehicle 103 and/or sensors for determining a number of occupants 105.

As depicted in FIG. 2, the example device 201 generally includes a communications unit 202, a processing unit 203, a Random Access Memory (RAM) 204, a display screen 205, an input device 206, one or more wireless transceivers 208, one or more wired and/or wireless input/output (I/O) interfaces 209, a combined modulator/demodulator 210, a code Read Only Memory (ROM) 212, a common data and address bus 217, a controller 220, a static memory 222 storing one or more applications 223 (which may include one or more machine learning algorithms) a speaker 228, an imaging device 232, a microphone 233 and a GPS unit 234. The one or more applications 223 will be interchangeably referred to hereafter as the application 223, though different applications 223 may be used for different modes of the device 201, as described in further detail below.

However, while the device 201 is described with respect to including certain components, it is understood that the device 201 may be configured according to the functionality of a specific device, for example the device 101 and/or computing devices of the vehicle 103 and/or the rescue vehicles 109.

The example device 201 is described hereafter in further detail. As shown in FIG. 2, the device 201 includes the communications unit 202 coupled to the common data and address bus 217 of the processing unit 203. The device 201 may also include the one or more input devices 206 (e.g., keypad, pointing device, touch-sensitive surface, etc.) and the display screen 205 (which, in some examples, may be a touch screen and thus also act as an input device 206), each coupled to be in communication with the processing unit 203.

The speaker 228 may be present for reproducing audio that is decoded from voice or audio streams of calls received via the communications unit 202 for example to provide navigation instructions.

The imaging device 232 may provide video (still or moving images) of an area in a field of view of the device 201 for further processing by the processing unit 203 and/or for further transmission by the communications unit 202.

The microphone 233 may be present for capturing audio from a user and/or other environmental or background audio that is further processed by the processing unit 203 and/or is transmitted as voice or audio stream data, or as acoustical environment indications, by the communications unit 202. Indeed, when the device 201 comprises a computing device of the vehicle 103, the microphone 233 may be one of the sensors for detecting a condition of the occupant 105 and/or for receiving commands to initiate a request to assist the at least one occupant 105 of the vehicle 103.

The processing unit 203 may include the code Read Only Memory (ROM) 212 coupled to the common data and address bus 217 for storing data for initializing system components. The processing unit 203 may further include the controller 220 coupled, by the common data and address bus 217, to the Random-Access Memory (RAM) 204 and a static memory 222.

The communications unit 202 may include one or more wired and/or wireless input/output (I/O) interfaces 209 that are configurable to communicate with other devices, such as the vehicle 103, the rescue vehicles 109 (and/or the device 101 when the device 201 is at the vehicle 103 or the rescue vehicles 109).

For example, the communications unit 202 may include one or more wireless transceivers 208, such as a digital mobile radio (DMR) transceiver, a Project 25 (P25) transceiver, a terrestrial trunked radio (TETRA) transceiver, a Bluetooth transceiver, a Wi-Fi transceiver, for example operating in accordance with an IEEE 802.11 standard (e.g., 802.11a, 802.11b, 802.11g), an LTE transceiver, a Worldwide Interoperability for Microwave Access (WiMAX) transceiver, for example operating in accordance with an IEEE 802.16 standard, and/or another similar type of wireless transceiver configurable to communicate via a wireless radio network.

The communications unit 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210. When the device 201 comprises the device 101, the communications unit 202 is generally configured to communicate with the vehicle 103 and the plurality of rescue vehicles 109.

The controller 220 may include ports (e.g. hardware ports) for coupling to the display screen 205, the input device 206, the imaging device 232, the speaker 228 and/or the microphone 233.

The controller 220 includes one or more logic circuits, one or more processors, one or more microprocessors, one or more ASIC (application-specific integrated circuits) and one or more FPGA (field-programmable gate arrays), and/or another electronic device. In some examples, for example when the device 201 includes functionality of the device 101, the controller 220 and/or the device 201 is not a generic controller and/or a generic device, but a device specifically configured to implement functionality for transporting occupants of vehicles to a location for assistance. For example, in some examples, the device 201 and/or the controller 220 specifically comprises a computer executable engine configured to implement specific functionality for transporting occupants of vehicles to a location for assistance.

When the device 201 includes functionality of the device 101, the controller 220 is generally communicatively coupled to the communications unit 202, and the controller 220 generally has access to the map data 113, for example as stored at the memory 222 and/or at the map server 111 via the communications unit 202.

The static memory 222 is a machine readable medium that stores machine readable instructions to implement one or more programs or applications. Example machine readable media include a non-volatile storage unit (e.g. Erasable Electronic Programmable Read Only Memory (“EEPROM”), Flash Memory) and/or a volatile storage unit (e.g. random-access memory (“RAM”)). In the example of FIG. 2, programming instructions (e.g., machine readable instructions) that implement the functional teachings of the device 201 as described herein are maintained, persistently, at the memory 222 and used by the controller 220 which makes appropriate utilization of volatile storage during the execution of such programming instructions.

In particular, for example when the device 201 includes functionality of the device 101, the memory 222 stores instructions corresponding to the application 223 that, when executed by the controller 220, enables the controller 220 to implement functionality for transporting occupants of vehicles to a location for assistance. In illustrated examples, when the controller 220 executes the application 223, the controller 220 is enabled to: receive, from the vehicle 103, via the communications unit 202, a request to assist at least one occupant 105 of the vehicle 103; determine, from the map data 113, a combination of a meeting place and a corresponding rescue vehicle 109, selected from the plurality of rescue vehicles 109, which minimizes a total travel time of the vehicle 103 from a current location 133 to the meeting place, and the corresponding rescue vehicle 109 from the meeting place to the location 131 for assisting the at least one occupant; and transmit, using the communications unit 202, to each of the vehicle 103 and the corresponding rescue vehicle 109, respective navigation instructions to the meeting place.

The application 223 may include one or more machine learning algorithms which may include, but are not limited to: a generalized linear regression algorithm; a random forest algorithm; a support vector machine algorithm; a gradient boosting regression algorithm; a decision tree algorithm; a generalized additive model; neural network algorithms; deep learning algorithms; evolutionary programming algorithms; Bayesian inference algorithms, reinforcement learning algorithms, and the like.

However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like, in some public safety environments. However, any suitable machine learning algorithm is within the scope of the present specification.

Indeed, the example device 201 may initially be operated in a learning mode to “teach” the machine learning algorithm(s) of the example device 201 to determine, from the map data 113, a combination of a meeting place and a corresponding rescue vehicle 109, selected from the plurality of rescue vehicles 109, which minimizes a total travel time of the vehicle 103 from a current location 133 to the meeting place, and the corresponding rescue vehicle 109 from the meeting place to the location 131 for assisting the at least one occupant; later, feedback from searching may be provided to the machine learning algorithm(s) of the example device 201 to improve determination, from the map data 113, a combination of a meeting place and a corresponding rescue vehicle 109, selected from the plurality of rescue vehicles 109, which minimizes a total travel time of the vehicle 103 from a current location 133 to the meeting place, and the corresponding rescue vehicle 109 from the meeting place to the location 131 for assisting the at least one occupant. In this manner, the machine learning algorithm(s) of the example device 201 are taught over time to determine successful outputs from given inputs.

Furthermore, different applications 223 may correspond to different machine learning algorithms, and/or different modes of the device 201. For example, different combinations of one or more different machine learning algorithms may be executed depending on a preconfigured and/or selected mode of the device 201.

Furthermore, the functionality of the system 100 and/or the device 201 may be distributed among a plurality of devices of the system 100 including, but not limited to, the vehicle 103 and the rescue vehicles 109 and/or any cloud based devices.

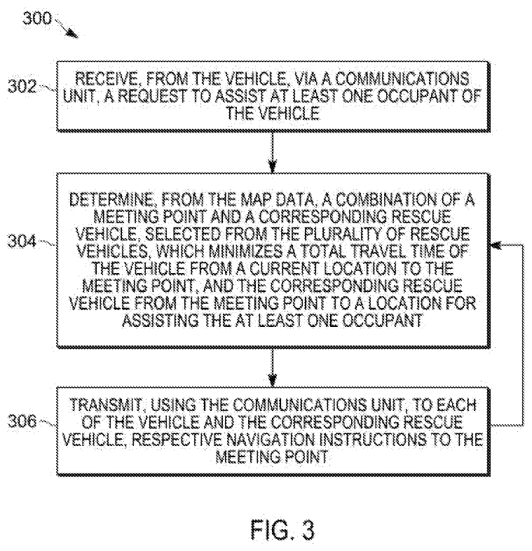

Attention is now directed to FIG. 3 which depicts a flowchart representative of a method 300 for transporting occupants of vehicles to a location for assistance. The operations of the method 300 of FIG. 3 correspond to machine readable instructions that are executed by, for example, the example computing device 201, and specifically by the controller 220 of the example computing device 201. In the illustrated example, the instructions represented by the blocks of FIG. 3 are stored at the memory 222 for example, as the application 223. The method 300 of FIG. 3 is one way in which the controller 220 and/or the example computing device 201 and/or the system 100 is configured. Furthermore, the following discussion of the method 300 of FIG. 3 will lead to a further understanding of the system 100, and its various components. However, it is to be understood that the method 300 and/or the system 100 may be varied, and need not work exactly as discussed herein in conjunction with each other, and that such variations are within the scope of present examples.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100 of FIG. 1, as well.

Furthermore, while it is understood by a person of skill in the art hereafter that the method 300 is performed at the device 201, the method 300 may be performed at one or more of the devices of the system 100, for example at a combination of one or more of the device 101, the vehicle 103 and the rescue vehicles 109.

At a block 302, the controller 220 of the device 201 receives, from the vehicle 103, via the communications unit 202, a request to assist at least one occupant 105 of the vehicle 103. The request may be transmitted by the vehicle 103 when sensors at the vehicle 103 detect that the occupant 105 requires medical assistance and/or when the sensors at the vehicle 103 detect a condition and/or medical condition of the occupant 105 and/or when the occupant actuates a button and the like at the vehicle 103 to initiate transmission of the request to assist at least one occupant 105 of the vehicle 103 to the device 101 (e.g. the device 201).

In some examples, the request to assist at least one occupant 105 of the vehicle 103 may further include one or more of a state of the vehicle 103, a condition of the at least one occupant 105, a current location of the vehicle 103, and a number of occupants 105 needing assistance.

At a block 304, the controller 220 of the device 201 determines, from the map data 113, a combination of a meeting place and a corresponding rescue vehicle 109, selected from the plurality of rescue vehicles 109, which minimizes a total travel time of the vehicle 103 from a current location 133 to the meeting place, and the corresponding rescue vehicle 109 from the meeting place to the location 131 for assisting the at least one occupant 105.

Indeed, a person of skill in the art understands that the total travel time of the vehicle 103 from a current location 133 to the meeting place, and the corresponding rescue vehicle 109 from the meeting place to the location 131 for assisting the at least one occupant comprises the time for transporting the occupant 105 requiring assistance from a current location 133 to a determined meeting place (e.g. using the vehicle 103), and from the determined meeting place to the location 131 (e.g. using a rescue vehicle 109).

In particular, the controller 220 implementing the block 304 is to determine a fastest time to transport the occupant 105 requiring assistance to the location 131, using the vehicle 103 and the rescue vehicle 109.

For example, the controller 220 may be configured to determine the combination of the meeting place and the corresponding rescue vehicle 109 by: determining a respective meeting place for each of the plurality of rescue vehicles 109 that minimizes a respective total travel time of the vehicle 103 from the current location 133 to the respective meeting place, and of a respective corresponding rescue vehicle 109 from the respective meeting place to the location 131 for assisting the at least one occupant; selecting respective meeting places which are available to the vehicle 103, and respective corresponding rescue vehicles 109; and selecting the combination of the meeting place and the corresponding rescue vehicle 109 from the respective meeting places which are available to the vehicle 103, and the corresponding rescue vehicle 109, with a shortest total travel time.

Hence, for example, different respective meeting places may be selected for each of the rescue vehicles 109, each of which minimizes the respective travel time of the occupant 105 from the current location 133 to the respective meeting place and then to the location 131. One or more of the respective meeting places may be unavailable to the vehicle 103 and/or a rescue vehicle 109, for example due to weather conditions, traffic conditions, a condition of the occupant 105, a state of the vehicle 103 (e.g. given damage to the vehicle 103 may disqualify the vehicle 103 from travelling on certain roads, such as expressways), and the like. From the respective meeting places that are available, the combination of the meeting place and the corresponding rescue vehicle 109 is selected, with a shortest total travel time of the occupant 105 to the location 131.

Furthermore, in some examples, given rescue vehicles 109 may be excluded from the selection of the combination of a respective meeting place and rescue vehicle 109. For example, a given rescue vehicle 109 may be unequipped to handle a given medical condition of an occupant 105: in particular, the occupant 105 may be having a heart attack and hence only rescue vehicles 109 that include medical equipment for handling a heart attack (such as defibrillators, and the like) may be selected in the combination of a respective meeting place and rescue vehicle 109 at the block 304. In yet further examples, when a condition of the occupant 105 is not life threatening, others of the rescue vehicle 109 may be excluded from the selection of the combination of a respective meeting place and rescue vehicle 109; for example, helicopters may be an expensive resource to deploy in these instances and hence they may be excluded from the selection of the combination of a respective meeting place and rescue vehicle 109 (e.g. based on a given condition of the occupant 105). Hence, in these examples, the device 201 has access to capabilities of the rescue vehicles 109 and/or one or more rankings of the rescue vehicles 109 by cost and the like. Such rankings may be stored at the memory 222 and/or one or more servers and/or cloud based devices for managing the rescue vehicles 109 and with which the device 201 (e.g. the device 101) is in communication.

Furthermore, the capabilities of the rescue vehicles 109 may include a maximum available speed for a rescue vehicle 109 which may also be used to determine the total travel time at the block 304.

In further examples, the controller 220 has access to one or more of the traffic data 117 and weather data 121 (e.g. via the network 107), and the controller 220 may be further configured to: determine, from the map data 113, the traffic data 117 and the weather data 121, the combination of the meeting place and the corresponding rescue vehicle 109 which minimizes the total travel time. For example, some roads may not be passable and/or the weather may not be suitable for using an air-based rescue vehicle 109 (e.g. due to winds, storms, snow and the like).

In some examples, the request to assist at least one occupant 105 of the vehicle 103 may further include one or more of a state of the vehicle 103, a condition of the at least one occupant 105, and a number of occupants 105 needing assistance, and the controller 220 may be further configured to: determine, from the map data 113, and one or more of a state of the vehicle 103, a condition of the at least one occupant 105, and the number of occupants 105 needing assistance, the combination of the meeting place and the corresponding rescue vehicle 109 which minimizes the total travel time.

For example, the state of the vehicle 103 may limit where a meeting place may be located (e.g. as the vehicle 103 may have a limited and/or reduced range of travel and/or may not be able to drive and/or may be travelling in a given direction and/or may or may not be able to turn around and travel in another direction). In another example, a condition of the at least one occupant 105 may indicate that the occupant 105 should not be transported over bumpy roads (e.g. due to a head injury). In yet a further example, when more than one occupant 105 requires assistance, more than one rescue vehicle 109 may be deployed to one or more meeting places and/or a rescue vehicle 109 may be selected which can accommodate the number of occupants 105 requiring assistance.

Furthermore, the total travel time as determined by the controller 220 may include one or more of: a transfer time period to transfer the at least one occupant 105 from the vehicle 103 to the corresponding rescue vehicle 109 at the meeting place; and a waiting time period of the vehicle 103 at the meeting place to wait for the corresponding rescue vehicle 109 to arrive at the meeting place. The transfer time period may be preconfigured and stored in the memory 222 and/or at the application 223 and/or estimated using machine learning algorithms, and the like. In yet further examples, for example when there is a distance at the meeting place between respective points where the vehicle 103 and the corresponding rescue vehicle 109 can stop, the transfer time period may include a time to transfer the occupant 105 between the points, which may depend on weather conditions, geographic features, and the like, at the meeting place, as determined from the weather data 121 and the map data 113.

The waiting time period of the vehicle 103 at the meeting place to wait for the corresponding rescue vehicle 109 to arrive at the meeting place may be determined when the travel time of the corresponding rescue vehicle 109 to the meeting place is longer than the travel time of the vehicle 103 to the meeting place.

Furthermore, the controller 220 may select the location 131 for assisting the at least one occupant 105 from the map data 113. For example, while the map data 113 of FIG. 1 depicts only one location 131 for assisting the at least one occupant 105, the map data 113 may include more than one location for assisting the occupant 105, and the location 131 may be selected based one or more on minimizing a total travel time to a location for assisting the occupant 105, a condition of the occupant 105 (e.g. the occupant 105 having given minor injuries may be transported to a clinic, while the occupant 105 having given major injuries may be transported to a hospital).

At a block 306, the controller 220 of the device 201 transmits, using the communications unit 202, to each of the vehicle 103 and the corresponding rescue vehicle 109, respective navigation instructions to the meeting place. In examples where the vehicle 103 and/or the corresponding rescue vehicle 109 are autonomous vehicles, the respective navigation instructions may comprise instructions for implementation by an autonomous vehicle navigation system. Alternatively, and/or in addition to the instructions for implementation by an autonomous vehicle navigation system, the respective navigation instructions may comprise instructions that may be provided at an output device (e.g. a speaker and/or a display screen) of the vehicle 103 and/or the corresponding rescue vehicle 109 for implementation by a respective occupant and/or driver of the vehicle 103 and/or the corresponding rescue vehicle 109. Furthermore, the navigation instructions transmitted to the corresponding rescue vehicle 109 may further include navigation instructions from the meeting place to the location 131 for the corresponding rescue vehicle 109.

As further depicted in FIG. 3, the controller 220 of the device 201 may again implement the blocks 304, 306, for example when traffic data 117 and/or weather data 121 changes which results in an increase in the total travel time determined at the block 306, based on a current position of each of the vehicle 103 and the corresponding rescue vehicle 109. In these examples, controller 220 may be further configured to, after transmitting the respective navigation instructions (e.g. at the block 306): dynamically change the total travel time based on one or more of the traffic data 117 and the weather data 121; and, when respective total travel time for an updated meeting place is less than the total travel time: change the meeting place to the updated meeting place; and transmit, to each of the vehicle 103 and the corresponding rescue vehicle 109, respective updated navigation instructions to the updated meeting place. Hence, in these examples the block 304 is implemented at least a second time to determine an updated meeting place using based on a respective current position of each of the vehicle 103 and the corresponding rescue vehicle 109; the block 306 is then implemented at least a second time to reroute the vehicle 103 and the corresponding rescue vehicle 109 to the updated meeting place. Hence, in these examples, the total travel time for the initially selected meeting place increases and the meeting place is changed to the updated meeting place. In these examples, the block 304 is again implemented. The blocks 304, 306 may be repeated any number of times to continue to dynamically minimize the total travel time for transporting the occupant 105 to the location 131.

In yet further examples, the controller 220 may continue to monitor total travel times for other meeting places (e.g. based on one or more of the traffic data 117 and the weather data 121, and based on a current position of each of the vehicle 103 and the corresponding rescue vehicle 109) and change the meeting place to an updated meeting place when a respective total travel time for the updated meeting place is less than the total travel time for the initially selected meeting place, even when the total travel time for the initially selected meeting place doesn't change. For example, the controller 220 may be further configured to, after transmitting the respective navigation instructions (e.g. at the block 306): when a respective total travel time for an updated meeting place is shorter than the total travel time to the meeting place, as determined from one or more of the traffic data 117 and the weather data 121: change the meeting place to the updated meeting place; and transmit, to each of the vehicle 103 and the corresponding rescue vehicle 109, respective updated navigation instructions to the updated meeting place. Again, the blocks 304, 306 may be repeated any number of times to continue to dynamically minimize the total travel time for transporting the occupant 105 to the location 131.

In yet further examples, the meeting place may be updated after transmission of the navigation instructions 539 based on one or more of an updated state of the vehicle 103, and/or an updated condition of the occupant 105; in such examples, it is understood that the vehicle 103 may continue to transmit, the device 101, a current updated state of the vehicle 103 and/or a current updated condition of the occupant 105. Hence, if the state of the vehicle 103 changed (e.g. the vehicle breaks down and/or experiences further damage), and/or if a medical condition of the occupant 105 gets worse and/or changes, an updated meeting place can be selected.

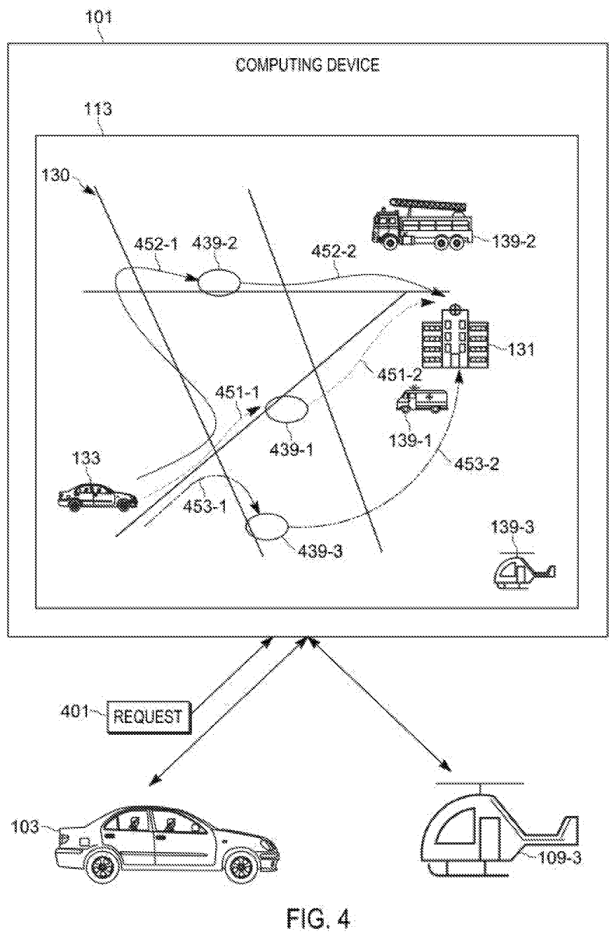

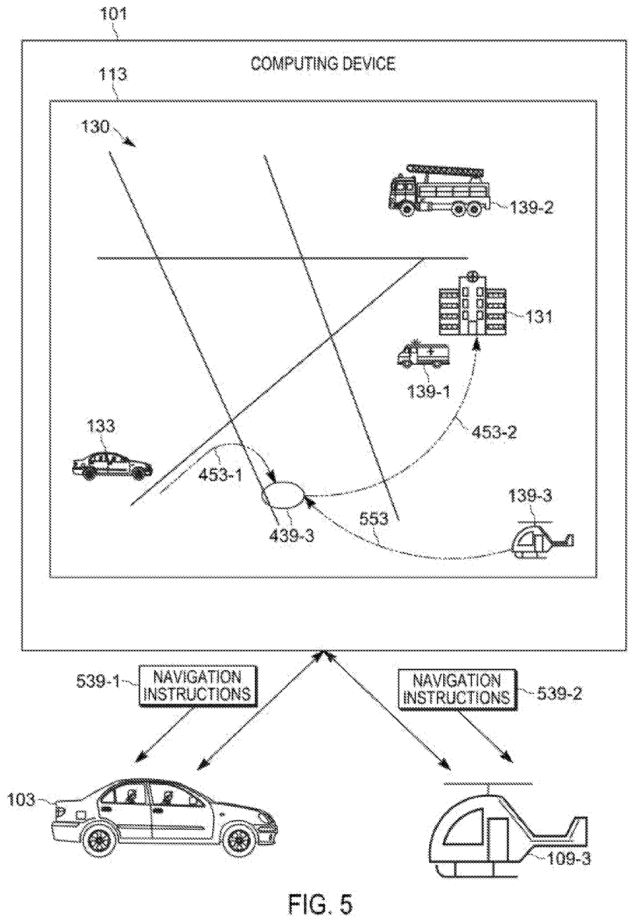

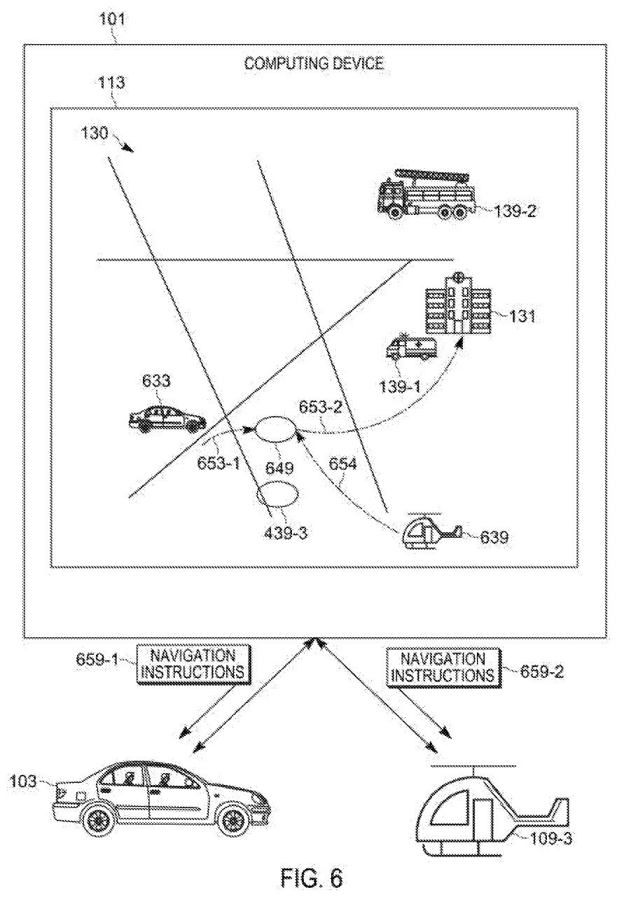

Attention is next directed to FIG. 4, FIG. 5 and FIG. 6 which depicts an example of the method 300. In particular, for simplicity FIG. 4, FIG. 5 and FIG. 6 each depict a subset of the components of the system 100 and in particular the device 101, the vehicle 103 and the rescue vehicle 109-3 (e.g. the helicopter), as well as communication links therebetween. However, the other components of the system 100 are understood to be present. In FIG. 4, FIG. 5 and FIG. 6, the device 101 is implementing the method 300.

For example, with reference to FIG. 4, the device 101 is receiving (e.g. at the block 302 of the method 300), from the vehicle 103, a request 401 to assist at least one occupant 105 of the vehicle 103.

As also depicted in FIG. 4, the device 101 determines (e.g. at the block 304 of the method 300), from the map data 113, a combination of a meeting place and a corresponding rescue vehicle 109, selected from the plurality of rescue vehicles 109, which minimizes a total travel time of the vehicle 103 from the current location 133 to the meeting place, and the corresponding rescue vehicle 109 from the meeting place to the location 131 for assisting the at least one occupant 105. As in FIG. 1, the map data 113 further shows current positions 139 of the rescue vehicles 109.

For example, as depicted in FIG. 4, the device 101 determines a respective meeting place 439-1, 439-2, 439-3 for each of the plurality of rescue vehicles 109-1, 109-2, 109-3. The meeting places 439-1, 439-2, 439-3 are interchangeably referred to hereafter, collectively, as the meeting places 439 and, generically, as a meeting place 439.

Each respective meeting place 439 is selected to minimize a respective total travel time for the vehicle 103 to a respective meeting place 439 and from a respective meeting place 439 to the location 131 for a corresponding respective rescue vehicle 109.

Hence, for example, the meeting place 439-1 is selected to minimize a total travel time for the vehicle 103 to the meeting place 439-1, and for the rescue vehicle 109-1 (e.g. the ambulance at the location 139-1) from the meeting place 439-1 to the location 131; indeed, the meeting place 439-1 may be selected from a plurality of meeting places that the vehicle 103 may meet the ambulance, with the meeting place 439-1 being the meeting place that results in the shortest travel time for an occupant 105 of the vehicle 103 requiring assistance to travel to the location 131 when transported by the ambulance. FIG. 4 also shows a route 451-1 of the vehicle 103 to the meeting place 439-1 along roads, and a route 451-2 of the ambulance from the meeting place 439-1 to the location 131 along roads, as determined by the device 101. The location of the meeting place 439-1 may also be determined by taking into account the travel time of the rescue vehicle 109-1 to the meeting place 439-1; in general, the meeting place 439-1 may be selected further based on minimizing a rescue vehicle travel time of the rescue vehicle 109-1 from the current location 139-1 to the meeting place 439-1.

Similarly, the meeting place 439-2 is selected to minimize a total travel time for the vehicle 103 to the meeting place 439-2, and for the rescue vehicle 109-2 (e.g. the fire truck at the location 139-2) from the meeting place 439-2 to the location 131; indeed, the meeting place 439-2 may be selected from a plurality of meeting places that the vehicle 103 may meet the fire truck, with the meeting place 439-2 being the meeting place that results in the shortest travel time for an occupant 105 of the vehicle 103 requiring assistance to travel to the location 131 when transported by the fire truck. FIG. 4 also shows a route 452-1 of the vehicle 103 to the meeting place 439-2 along roads, and a route 452-2 of the fire truck from the meeting place 439-2 to the location 131 along roads, as determined by the device 101. The location of the meeting place 439-2 may also be determined by taking into account the travel time of the rescue vehicle 109-2 to the meeting place 439-2; in general, the meeting place 439-2 may be selected further based on minimizing a rescue vehicle travel time of the rescue vehicle 109-2 from the current location 139-2 to the meeting place 439-2.

Similarly, the meeting place 439-3 is selected to minimize a total travel time for the vehicle 103 to the meeting place 439-3, and for the rescue vehicle 109-3 (e.g. the helicopter at the location 139-3) from the meeting place 439-3 to the location 131; indeed, the meeting place 439-3 may be selected from a plurality of meeting places that the vehicle 103 may meet the helicopter, with the meeting place 439-3 being the meeting place that results in the shortest travel time for an occupant 105 of the vehicle 103 requiring assistance to travel to the location 131 when transported by the helicopter. The location of the meeting place 439-3 may also be determined by taking into account the travel time of the rescue vehicle 109-3 to the meeting place 439-3; in general, the meeting place 439-3 may be selected further based on minimizing a rescue vehicle travel time of the rescue vehicle 109-3 from the current location 139-3 to the meeting place 439-3.

FIG. 4 also shows a route 453-1 of the vehicle 103 to the meeting place 439-3, and a route 453-2 of the helicopter from the meeting place 439-3 to the location 131, as determined by the device 101. In contrast to the routes 451-2, 452-2, the route 453-2 is an air-based route that does not follow roads of the map data 113.

The device 101 compares the respective total travel time for each of the routes 451-1, 451-2, the routes 452-1- 452-2, and the routes 453-1, 453-2, and selects the meeting place 439 and corresponding rescue vehicle 109 with the shortest total travel time represented by each of the routes 451-1, 451-2, the routes 452-1- 452-2, and the routes 453-1, 453-2.

For example, with reference to FIG. 5, the device 101 may determine that the combination of the meeting place 439-3 and the rescue vehicle 109-3 has the shortest total travel time, transmit (e.g. at the block 306), to the vehicle 103, navigation instructions 539-1 for the vehicle 103 to navigate from the current location 133 to the meeting place 439-3, and further transmit (e.g. at the block 306), to the rescue vehicle 109-3, navigation instructions 539-2 for the rescue vehicle 109-3 to navigate from the current location 139-3 of the rescue vehicle 109-3 to the meeting place 439-3, for example along a route 553. The route 553 may be selected to minimize a travel time for the rescue vehicle 109-3 to navigate from a current location 139-3 of the rescue vehicle 109-3 to the meeting place 439-3. The navigation instructions 539-2 may also include navigation instructions for the rescue vehicle 109-3 to navigate from the meeting place 439-3 to the location 131 along the route 453-2.

Attention is next directed to FIG. 6 which depicts the map data 113 updated with a current position 633 of the vehicle 103 and current position 639 of the rescue vehicle 109-3 each on route to the meeting place 439-3. However, while the vehicle 103 and the rescue vehicle 109-3 are on route to the meeting place 439-3, the device 101 may determine that an updated meeting place 649 presently has a shorter total travel time than a total travel time for the meeting place 439-3. The shorter total travel time for the updated meeting place 649 may be due to changing traffic conditions and/or weather conditions and/or may be due to the meeting place 439-3 no longer being suitable for the rescue vehicle 109-3 and/or the vehicle 103 (e.g. due to weather conditions and/or traffic conditions). Indeed, when the block 304 was initially implemented the meeting place 649 may have been considered by the device 101, but discarded in favor of the meeting place 439-3 as having a longer total travel time due to weather conditions and/or traffic conditions, and the like, when the vehicle 103 was at the location 133 and the rescue vehicle 109-3 was at the location 139-3.

Hence, in FIG. 6, the device 101 determines a combined total travel time for the vehicle 103 to travel from the current position 633 along a route 653-1 to the updated meeting place 649, and for the rescue vehicle 109-3 to travel from the updated meeting place 649 to the location 131 along a route 653-2. The combined total travel time is compared to the current total travel time to the meeting place 439-3 and when the combined total travel time for the meeting place 649 is shorter than the current total travel time to the meeting place 439-3, the meeting places for the vehicle 103 and the rescue vehicle 109-3 is changed to the updated meeting place 649.

Hence, the device 101 transmits (e.g. at the block 306), to the vehicle 103, navigation instructions 659-1 for the vehicle 103 to navigate from the current location 633 to the meeting place 649, and further transmits, to the rescue vehicle 109-3, navigation instructions 659-2 for the rescue vehicle 109-3 to navigate from the current location 639 of the rescue vehicle 109-3 to the meeting place 649, for example along a route 654. The route 654 may be selected to minimize a travel time for the rescue vehicle 109-3 to navigate from the current location 639 of the rescue vehicle 109-3 to the updated meeting place 649. The navigation instructions 659-2 may also include navigation instructions for the rescue vehicle 109-3 to navigate from the meeting place 649 to the location 131 along the route 653-2.

While the example in FIG. 6 has been described with respect to updating a meeting place due to changes in travel time while the vehicle 103 and a rescue vehicle 109 are on-route to an initially selected meeting place, a meeting place may be updated based on other factors and/or at other times. For example, such factors may include, but are not limited to: an initially selected rescue vehicle 109 being replaced with another rescue vehicle 109, for example due to damage, upon initial selection of a rescue vehicle 109; an initially selected rescue vehicle 109 being replaced with another rescue vehicle 109, for example due to damage and/or an accident that occurs while the initially selected rescue vehicle 109 is on route to the initially selected meeting place; an initially selected rescue vehicle 109 being replaced with another rescue vehicle 109, for example due to a route to the initially selected meeting place becoming impassable while the initially selected rescue vehicle 109 is on route to the initially selected meeting place; a route to the initially selected meeting place becoming impassable such that the initially selected rescue vehicle 109 and the vehicle 103 are both is rerouted to a new meeting place (e.g. similar to FIG. 6); and the like.

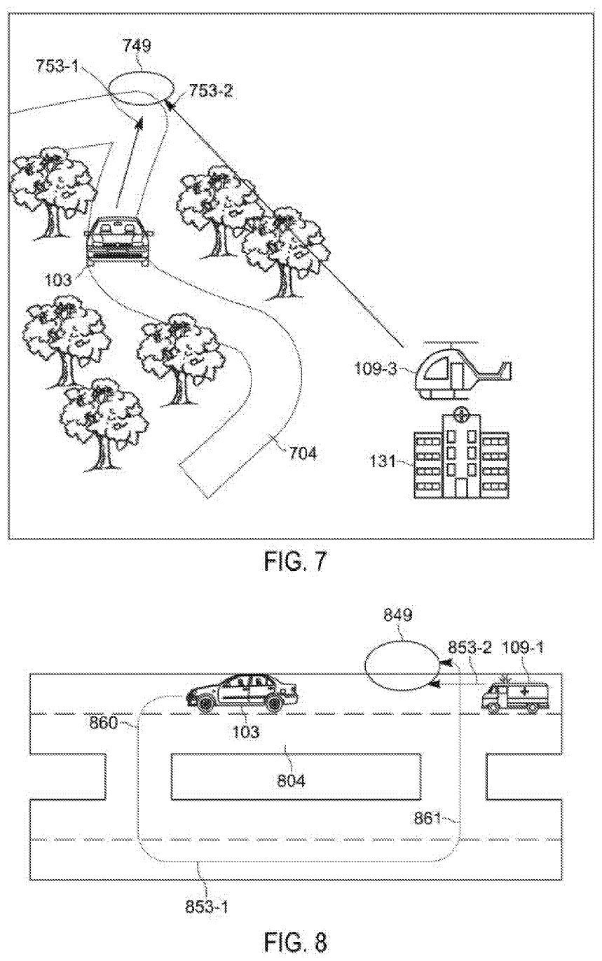

Attention is next directed to FIG. 7 which depicts a scenario that may occur when the method 300 is implemented at the device 101, and the like. FIG. 7 is a depiction of the vehicle 103 travelling along a road 704 through a forest; in this scenario, the vehicle 103 may comprise an autonomous vehicle. An occupant and/or a sole occupant of the vehicle 103 may lose consciousness; sensors at the vehicle 103 may detect that the occupant has lost consciousness and transmit a request for assistance to the device 101; while the device 101 is not depicted in FIG. 7, a person of skill in the art understands that the vehicle 103, and rescue vehicles 109, are in communication with the device 101. The device 101 determines the location 131 to assist the occupant of the vehicle 103, selects the rescue vehicle 109-3 (e.g. the helicopter) and a corresponding meeting place 749 as described above, and transmits navigation instructions (not depicted) to each of the vehicle 103 and the rescue vehicle 109-3 to the meeting place 749. For example, the navigation instructions for the vehicle 103 may be along a route 753-1, in an opposite direction of the location 131, and the navigation instructions for the helicopter may be along a route 753-2. In this scenario, the meeting place 749 is in an opposite direction of the location 131, however the meeting place 749 is the location nearest to the vehicle 103 where the helicopter can safely land. Hence, selection of the meeting places 749 may be counter-intuitive without implementation of the method 300 at the device 101, and the like. Indeed, without the device 101 implementing the method 300, the vehicle 103 may navigate to a different meeting place that may be in a direction of the location 131, but results in a longer total travel time for the occupant of the vehicle 103 to travel to the location 131 via the helicopter.

Attention is next directed to FIG. 8 which depicts another scenario that may occur when the method 300 is implemented at the device 101, and the like. FIG. 8 is a depiction of the vehicle 103 travelling along a divided road 804 with the rescue vehicle 109-1 (e.g. the ambulance) travelling behind the vehicle 103 in the same direction along the divided road 804; in this scenario, the vehicle 103 may comprise an autonomous vehicle. An occupant and/or a sole occupant of the vehicle 103 may lose consciousness; sensors at the vehicle 103 may detect that the occupant has lost consciousness and transmit a request for assistance to the device 101; while the device 101 is not depicted in FIG. 8, a person of skill in the art understands that the vehicle 103, and the rescue vehicles 109, are in communication with the device 101. The device 101 determines the location 131 (also not depicted in FIG. 8 but nonetheless understood to be present) to assist the occupant of the vehicle 103, selects the rescue vehicle 109-1 (e.g. the ambulance) and a corresponding meeting place 849 as described above, and transmits navigation instructions to each of the vehicle 103 and the rescue vehicle 109-1 to the meeting place 849. For example, the navigation instructions for the vehicle 103 may be along a route 853-1, in which the vehicle 103 changes direction, and the navigation instructions for the ambulance may be along a route 853-2. In this scenario, the meeting place 849 is in an opposite direction of direction in which the vehicle 103 is travelling and the route 853-1 hence causes the vehicle to change direction using a nearest exit and/or crossover point 860 of the divided road 804 to travel in an opposite direction to another exit and/or another crossover point 861 back to the initial direction that the vehicle 103 was travelling and/or in a same direction that the ambulance is travelling along the route 853-2. Hence, selection of the meeting places 849 may be counter-intuitive without implementation of the method 300 at the device 101, and the like. Indeed, without the device 101 implementing the method 300, the vehicle 103 may navigate to a different meeting place that may be in a direction that the vehicle 103 is currently travelling, but results in a longer total travel time for the occupant of the vehicle 103 to travel to the location 131 via the ambulance.

Provided herein is a device, system and method for transporting occupants of vehicles to a location for assistance. The device determines a combination of a meeting place and rescue vehicle which minimizes a total travel time of a vehicle from a current location to the meeting place, and the corresponding rescue vehicle from the meeting place to a location for assisting at least one occupant of the vehicle requiring assistance. As such, the provided device, system and method may select an optimal meeting point between a vehicle, including, but not limited to an autonomous vehicle, and an emergency services and/or rescue vehicle and coordinate their meeting at the meeting place to transfer the occupant of the vehicle to the rescue vehicle. Selection of the meeting place may occur using machine learning algorithms and may be based on a state of the vehicle and/or external conditions, such as traffic and/or weather, and other factors, to shorten transport of an occupant of the vehicle person to a hospital, for example.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

In this document, language of “at least one of X, Y, and Z” and “one or more of X, Y and Z” may be construed as X only, Y only, Z only, or any combination of two or more items X, Y, and Z (e.g., XYZ, XY, YZ, XZ, and the like). Similar logic may be applied for two or more items in any occurrence of “at least one . . . ” and “one or more . . . ” language.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A device comprising:
a communications unit configured to communicate with a vehicle and a plurality of rescue vehicles; and
a controller communicatively coupled to the communications unit,
the controller having access to map data,
the controller configured to:
receive, from the vehicle, via the communications unit, a request to assist at least one occupant of the vehicle;
determine, from the map data, a combination of a meeting place and a corresponding rescue vehicle, selected from the plurality of rescue vehicles, which minimizes a total travel time of the vehicle from a current location to the meeting place, and the corresponding rescue vehicle from the meeting place to a location for assisting the at least one occupant; and
transmit, using the communications unit, to each of the vehicle and the corresponding rescue vehicle, respective navigation instructions to the meeting place.

2. The device of claim 1, wherein the controller further has access to one or more of traffic data and weather data, the controller being further configured to:
determine, from the map data, the traffic data and the weather data, the combination of the meeting place and the corresponding rescue vehicle which minimizes the total travel time.

3. The device of claim 1, wherein the request to assist the at least one occupant of the vehicle includes one or more of a state of the vehicle, a condition of the at least one occupant, and a number of occupants needing assistance, the controller being further configured to:
determine, from the map data, and one or more of the state of the vehicle, the condition of the at least one occupant, and the number of occupants needing assistance, the combination of the meeting place and the corresponding rescue vehicle which minimizes the total travel time.

4. The device of claim 1, wherein the controller is further configured to determine the combination of the meeting place and the corresponding rescue vehicle by:
determining a respective meeting place for each of the plurality of rescue vehicles that minimizes a respective total travel time of the vehicle from a current location to the respective meeting place, and of a respective corresponding rescue vehicle from the respective meeting place to a location for assisting the at least one occupant;
selecting respective meeting places which are available to the vehicle, and respective corresponding rescue vehicles; and
selecting the combination of the meeting place and the corresponding rescue vehicle from the respective meeting places which are available to the vehicle, and the corresponding rescue vehicle, with a shortest total travel time.

5. The device of claim 1, wherein the plurality of rescue vehicles includes one or more of land-based rescue vehicles, air-based rescue vehicles and water-based vehicles.

6. The device of claim 1, wherein the total travel time as determined by the controller includes one or more of:
a transfer time period to transfer the at least one occupant from the vehicle to the corresponding rescue vehicle at the meeting place; and
a waiting time period of the vehicle at the meeting place to wait for the corresponding rescue vehicle to arrive at the meeting place.

7. The device of claim 1, wherein the controller is further configured to, after transmitting the respective navigation instructions:
when a respective total travel time for an updated meeting place is shorter than the total travel time to the meeting place, as determined from one or more of traffic data and weather data:
change the meeting place to the updated meeting place; and
transmit, to each of the vehicle and the corresponding rescue vehicle, respective updated navigation instructions to the updated meeting place.

8. The device of claim 1, wherein the controller is further configured to, after transmitting the respective navigation instructions:
dynamically change the total travel time based on one or more of traffic data and weather data; and,
when respective total travel time for an updated meeting place is less than the total travel time:
change the meeting place to the updated meeting place; and
transmit, to each of the vehicle and the corresponding rescue vehicle, respective updated navigation instructions to the updated meeting place.

9. The device of claim 1, wherein the controller is further configured to:
select the location for assisting the at least one occupant from the map data.

10. The device of claim 1, wherein the location for assisting the at least one occupant comprises one or more of a hospital, a clinic, a police station, a fire station, and an emergency medical services station.

11. The device of claim 1, wherein the controller is further configured to:
select the meeting place further based on minimizing a rescue vehicle travel time for the corresponding rescue vehicle to travel from a respective current location to the meeting place.

12. A method comprising:
receiving, at a controller, via a communications unit, from a vehicle, a request to assist at least one occupant of the vehicle;
determining, at the controller, from map data accessible by the controller, a combination of a meeting place and a corresponding rescue vehicle, selected from a plurality of rescue vehicles, which minimizes a total travel time of the vehicle from a current location to the meeting place, and the corresponding rescue vehicle from the meeting place to a location for assisting the at least one occupant; and
transmit, from the controller, using the communications unit, to each of the vehicle and the corresponding rescue vehicle, respective navigation instructions to the meeting place.

13. The method of claim 12, wherein the controller further has access to one or more of traffic data and weather data, the method further comprising:
determining, from the map data, the traffic data and the weather data, the combination of the meeting place and the corresponding rescue vehicle which minimizes the total travel time.

14. The method of claim 12, wherein the request to assist the at least one occupant of the vehicle includes one or more of a state of the vehicle, a condition of the at least one occupant, and a number of occupants needing assistance, the method further comprising:
determining, from the map data, and one or more of the state of the vehicle, the condition of the at least one occupant, and the number of occupants needing assistance, the combination of the meeting place and the corresponding rescue vehicle which minimizes the total travel time.

15. The method of claim 12, further comprising determining the combination of the meeting place and the corresponding rescue vehicle by:
determining a respective meeting place for each of the plurality of rescue vehicles that minimizes a respective total travel time of the vehicle from a current location to the respective meeting place, and of a respective corresponding rescue vehicle from the respective meeting place to a location for assisting the at least one occupant;
selecting respective meeting places which are available to the vehicle, and respective corresponding rescue vehicles; and
selecting the combination of the meeting place and the corresponding rescue vehicle from the respective meeting places which are available to the vehicle, and the corresponding rescue vehicle, with a shortest total travel time.

16. The method of claim 12, wherein the plurality of rescue vehicles includes one or more of land-based rescue vehicles, air-based rescue vehicles and water-based vehicles.

17. The method of claim 12, wherein the total travel time as determined by the controller includes one or more of:
a transfer time period to transfer the at least one occupant from the vehicle to the corresponding rescue vehicle at the meeting place; and
a waiting time period of the vehicle at the meeting place to wait for the corresponding rescue vehicle to arrive at the meeting place.

18. The method of claim 12, further comprising, after transmitting the respective navigation instructions:
when a respective total travel time for an updated meeting place is shorter than the total travel time to the meeting place, as determined from one or more of traffic data and weather data:
changing the meeting place to the updated meeting place; and
transmitting, to each of the vehicle and the corresponding rescue vehicle, respective updated navigation instructions to the updated meeting place.

19. The method of claim 12, further comprising, after transmitting the respective navigation instructions:
dynamically changing the total travel time based on one or more of traffic data and weather data; and,
when respective total travel time for an updated meeting place is less than the total travel time:
changing the meeting place to the updated meeting place; and
transmitting, to each of the vehicle and the corresponding rescue vehicle, respective updated navigation instructions to the updated meeting place.

20. The method of claim 12, further comprising selecting the location for assisting the at least one occupant from the map data.

21. The method of claim 12, wherein the location for assisting the at least one occupant comprises one or more of a hospital, a clinic, a police station, a fire station, and an emergency medical services station.

22. The method of claim 12, further comprising:
selecting the meeting place further based on minimizing a rescue vehicle travel time for the corresponding rescue vehicle to travel from a respective current location to the meeting place.
